(19) United States
(12) Patent Application Publication
(10) Pub. No.: US 2011/0154718 A1
(43) Pub. Date: Jun. 30, 2011

(54) Insect repeller

(76) Inventor: Richard O. Braun, Fayetteville, GA (US)

(21) Appl. No.: 12/655,391

(22) Filed: Dec. 30, 2009

(51) Int. Cl. A01M 29/00; A01M 1/14; B63B 21/20

(52) U.S. Cl. 43/114; 43/107; 114/230.2; 43/132.1

(57) ABSTRACT

The inventive concept presented is a device which serves to prevent the transit of ants and other crawling insects along a mooring line, rope, or similar structure. The preferred embodiment of the inventive concept is constructed of a three-piece assemblage comprising (1) a base unit having a flanged circular front face with an integral concentric tube (2) a tapered, dome-shaped weather shroud, and (3) an adapter sleeve within internal spikes/ridges for engaging a mooring line. The adapter sleeve is tightened onto the mooring line by indirectly applied manual axial force. The weather shroud is then latched into the base unit. A sticky, insect-repelling substance disposed within a circular cavity on the opposite side of the circular front face plate in the base unit serves to repel and/or prevent crawling insects from traversing the mooring line.

### CROSS-REFERENCES TO RELATED APPLICATIONS

There are no related applications

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX

Not applicable.

### BACKGROUND OF THE INVENTION

(1) Field of the Invention

This inventive concept is intended to solve a common problem for boat owners; the infestation of ants and other crawling insects onto their boats as they are docked and secured in place by mooring lines. Entry to the boats is usually gained by ants and other insects crawling from the secured shore or docking point of the mooring line, along the mooring line and then onto the vessel.

The method of prevention used herein involves establishing a device comprising a repellent barrier attached around a small segment of the diameter of a mooring line. As ants and/or other crawling insects attempt to traverse the mooring line, upon approaching the device they immediately sense a threat and are repelled. Thusly, access to the boat or water vessel is prevented.

(2) Description of the Related Art

In U.S. Pat. No. 4,769,943 (Sep. 13, 1988; Simpson, H.) a device is disclosed which consists of several variations of a plastic, flexible cuff (tubular or cylindrical) that may be affixed around a short length of the perimeter of a mooring line. The plastic material may be treated with an insecticidal agent or made of an insecticidal material.

An animal feeder featuring an upper circular container for the food, which sits atop a shaft-type device connected to a lower base portion containing an insect repellant or tacky trapping substance is disclosed in U.S. Pat. No. 4,953,506 (Sep. 4, 1990 Saunders, D).

The inventor of U.S. Pat. No. 5,881,671 (Mar. 15, 1999 Riedl, J.), devised an apparatus that prevents insects from reaching the inside of a pet food dish. The apparatus is designed to prevent the smell of food in the dish from “reaching a critical portion of the path of the food source” to the ground.

U.S. Pat. No. 6,513,281 (Apr. 22, 2003 Roberts, E.) presents a segmented holding device suitable for containing an object requiring protection from crawling insects (arthropods). An upper circular member receives the object and is then inserted within the inner circumference of a lower base member. A flange on the lower base member may contain an insect-deterring substance which prevents the insects from reaching the upper member and the protected object.

U.S. Pat. No. 6,779,311 (Apr. 24, 2004 Roberts, E.) features a one-piece unit that forms a continuous barrier when tightly clasped about the exterior of an object. Made of a pliable material, the device comprises a conical skirt that may be interiorly coated with an insect-deterring substance molded therein.

### BRIEF SUMMARY OF THE INVENTIVE CONCEPT

The inventive concept is an insect-repelling apparatus that is attachable to a mooring line which leads from a pier, dock, or shore-side tying point, to a boat.

The apparatus is essentially a three-component assemblage comprising (1) a “base unit” which is used to contain an insect repelling substance, (2) a dome-shaped “weather shroud” which is used to protect the insect repelling substance, and (3) an “adapter sleeve” composed of two “hemi sleeves,” which is used to secure the insect repeller to the mooring line. When the dockside or shore end of the mooring line is untied, this end of the mooring line is threaded through the base unit and the weather shroud. The shore end can then be re-tied to the shore tying point. A correctly-sized pair of hemi sleeves is placed around a chosen position on the mooring line and manually held in position to form the assembled adapter sleeve. The base unit is then moved in an axial direction over the adapter sleeve until both these components adhere to each other by the force of friction. When adhered to each other in this manner, the adapter sleeve and the base unit are secured onto the mooring line. The weather shroud is then moved over the base unit and secured onto the base unit by compatible male and female latches. A sticky, insect repelling substance, disposed within the base unit, serves to deter ants and other crawling insects from traversing the mooring line.

### BRIEF DESCRIPTION OF THE VIEWS OF THE DRAWINGS

The reader is advised that all drawings depict the component parts of the inventive concept mounted on a braided mooring line. However, the included drawings are for illustrative purposes only, and are not intended to foreclose usage of the device on other sizes and/or types of mooring lines.

FIG. 1 depicts a perspective (from land-side) view of the device fully assembled, and attached to a mooring line.

FIG. 2 illustrates a perspective (from boat-side) view of the insect repeller, fully assembled, and attached to a mooring line.

FIG. 3 presents a perspective (land-side) view of the weather shroud just prior to latching on the repellent base, with the adapter sleeve in place.

FIG. 4 gives a perspective (boat side) view of the repellent base unit with one of the hemi-sleeves slightly out of place, along with an interior view of the weather shroud.

FIG. 5 shows a two-sided view of a pair of hemi-sleeves, along with one of the hemi-sleeves in position on a mooring line.

FIG. 6 depicts a sectionalized perspective view of the repellent base unit with one of the hemi-sleeves in place within the cylindrical tube.

FIG. 7 illustrates a cross sectional view of a fully-assembled insect repeller, including the adapter sleeve, repellent base unit, and weather shroud, as mounted on a mooring line.

Table of Nomenclature & Component Numbers

| | |
|---|---|
| 1. | Insect repeller |
| 2. | Adapter sleeve (assembled) |
| 3. | Base unit |
| 4. | Weather shroud |
| 5. | Raised/spiked edges |
| 6. | Mooring line |
| 7. | Rounded flange (end of adapter sleeve) |
| 8. | Circular depression |
| 9. | Raised edge end |
| 10. | Relief cut |
| 11. | Circular front face (base unit) |
| 12. | Cylindrical tube |
| 13. | Extended end |
| 14. | Circular cavity |
| 15. | Barrier/repellent substance |
| 16. | Female locking notch |
| 17. | Small-end opening |
| 18. | Large-end opening |
| 19. | Male locking tab |
| 20. | Shroud locking direction |
| 21. | First hemi-sleeve |
| 22. | Second hemi-sleeve |
| 23. | Inner surface of hemi-sleeve |
| 24. | Outer surface of hemi-sleeve |

### DETAILED DESCRIPTION OF THE INVENTION

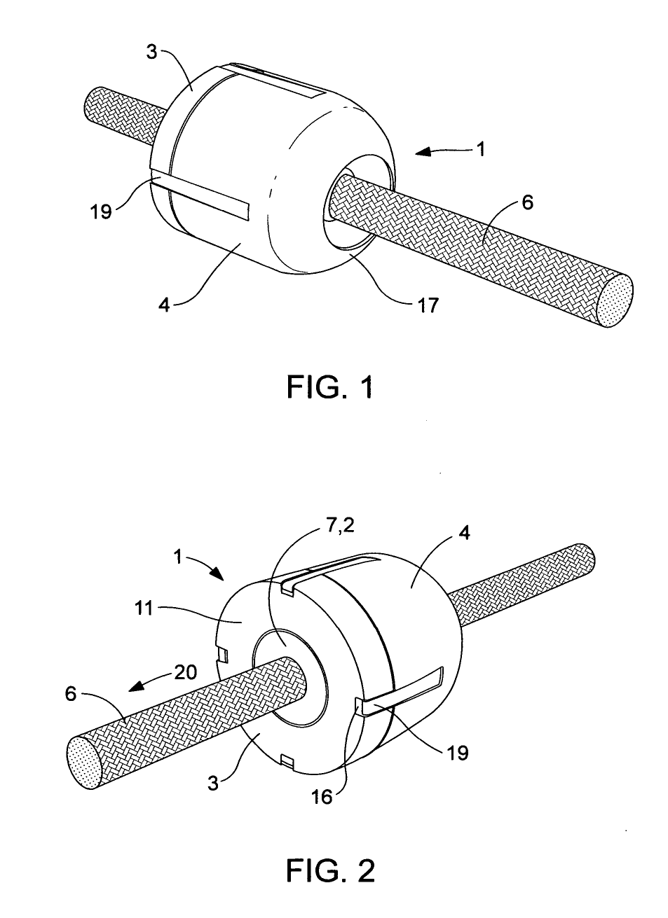

As we refer to FIG. 1, there is presented a general image of the insect repeller 1 attached to a mooring line 6, as the device would be seen from a dock, pier, or shoreline location. A plurality of male locking tabs 19 secures the weather shroud 4 to the base unit 3. The small end opening17 of the weather shroud 4 provides an amount of clearance from the mooring line 6, thus preventing insects from crawling over the exterior surface of the weather shroud 4.

In FIG. 2, the insect repeller 1 is shown as viewed from aboard a boat, yacht, or other water vessel. The weather shroud 4 is shown latched into the base unit 3 by virtue of the male locking tabs 19 engaged into female locking notches 16 of the base unit 3. The rounded flange 7 of the adapter sleeve 2 has been fitted into the circular depression 8 of the base unit 3 while the adapter sleeve 2 has been secured to the mooring line 6 by means of the locking action with the base unit 3.

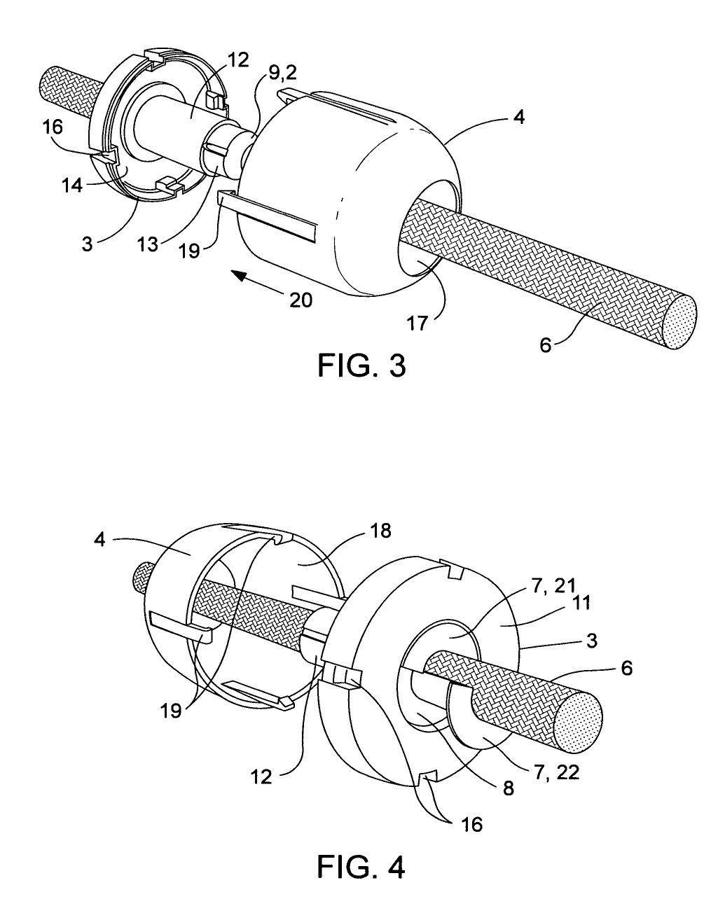

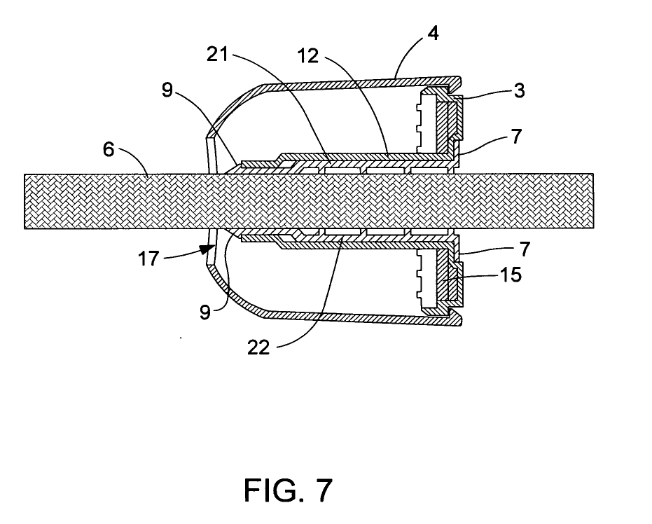

A shore-side exploded view of the insect repeller 1 is shown in FIG. 3, along with the weather shroud 4, in position to lock onto the base unit 3. Male locking tabs 19 lock into female locking notches 16 of the base unit 3. The cylindrical tube 12, an integral part of the base unit 3, is shown with the adapter sleeve 2 secured within. The depicted circular cavity 14 is used to contain the repellant substance 15 (also refer to FIG. 6 and FIG. 7). The raised edge 9 of the adapter sleeve 2 is shown in its locked position after its insertion into the cylindrical tube 12 from the front face 11 of the base unit 3.

As we refer to FIG. 4, a boat-side view of the insect repeller 1 is presented. The front face 11 of the base unit 3 is shown with one of the two hemi-sleeves (21) fully positioned into the base unit 3, and the other of the two hemi-sleeves 22 partially positioned into the base unit 3. Also depicted are the rounded flange ends 7 of the hemi-sleeves 21, 22, as they appear when positioned into the circular depression 8 of the base unit 3.

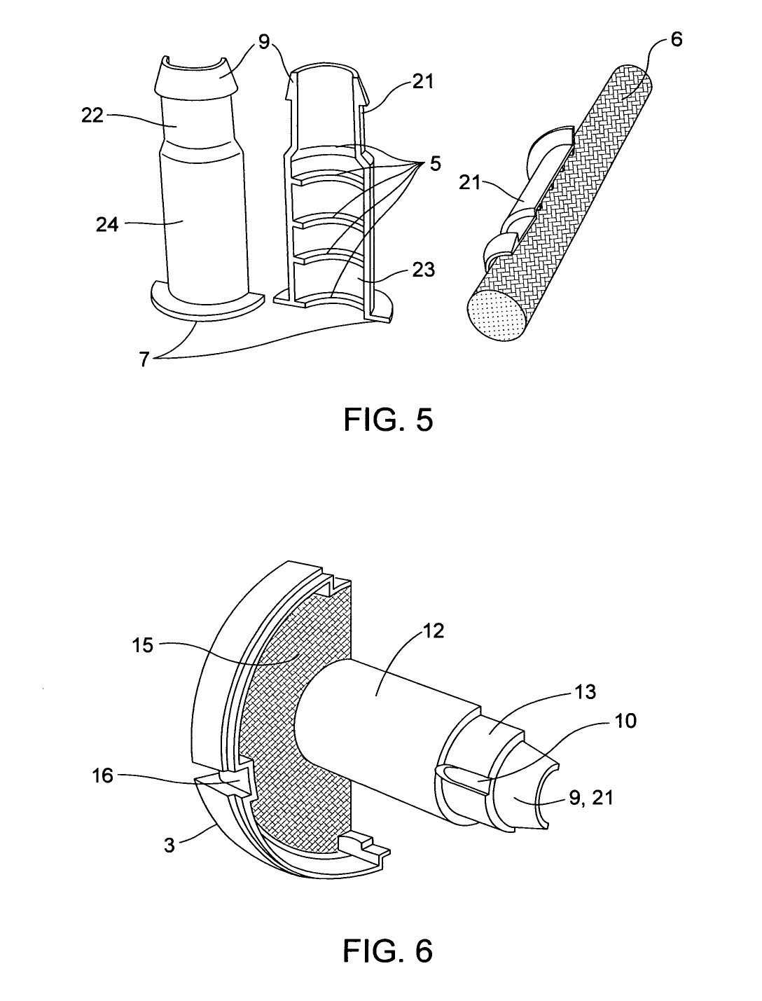

In viewing FIG. 5, interior and exterior views of the hemi-sleeves 21, 22 are presented. Also shown is one hemi-sleeve 21 pressed against a mooring line 6. The inner surface 23 of hemi-sleeve 21 depicts the raised/spiked edges 5. The rounded flange 7, along with the raised edge 9, are also presented.

FIG. 6 presents a shore-side reverse sectional view of the base unit 3 which shows the cylindrical tube 12 with its extended end 13 along with the relief cuts 10 in the extended end 13. The raised edge 9 of one of the hemi-sleeves 21 is shown in its locked position at the extended end 13 of the cylindrical tube 12. Also indicated is the repellant substance 15 in place within the circular cavity 14 of the base unit 3. The female locking notch 16 is displayed on the exterior perimeter of the base unit 3.

A cross-sectional view of the insect repeller 1 with all three components fully assembled and mounted on a mooring line 6 is shown in FIG. 7. The various parts are identified as a hemi-sleeve 21, the base unit 3, the weather shroud 4, and rounded flange 7. Other specific features are the repellant substance 15, the cylindrical tube 12, the raised edge 9, and the small end opening 17.

### Description of Components

The Adapter Sleeve: FIG. 5 presents two paired adapter hemi-sleeves 21, 22 which, when combined, form a tubular-shaped adapter sleeve 2 which secures itself to, and forms a seal around, the selected mooring line 6 (as seen in FIG. 5 and FIG. 7). There are three “standard” sizes of adapter sleeves 2, designed to accommodate the most common sized mooring lines. All three adapter sleeves 2 will have the same length and outside diameter, while the inside diameter will vary according to the diameter of the mooring line 6. The inside diameters of the adapter sleeves 2 are sized to fit a mooring line 6 of ⅜ in., ½ in, or a ⅝ in diameter. As seen from FIG. 5, the hemi-sleeves 21, 22 each have raised spiked edges 5 around their inner surface 23 to aid in securing the hemi-sleeves 21, 22 to the mooring line 6.

A rounded flange 7 (shown in FIGS. 2, 4, 5, and 7) extends outward from one end of each hemi-sleeve 21, 22, and forms a complete circular flange when the hemi-sleeves 21, 22 are combined. The rounded flange 7 is sized to fit into a circular depression 8 which is molded onto the circular front face 11 of the base unit 3, as more clearly shown in FIG. 2 and FIG. 4. The opposite end of each hemi-sleeve 21 and 22 has a raised edge 9 (FIG. 5) which forms a circular-shaped, raised edge 9 when the hemi-sleeves 21, 22, are combined. The raised edge 9, as shown in FIG. 6, enables the hemi-sleeves 21, 22 to lock into the base unit 3 after the raised edge 9 passes through the smaller, extended end 13 of the cylindrical tube 12.

The Base Unit: The base unit 3, as seen in FIG. 3 and FIG. 4, has a circular front face 11 with a circular depression 8 at its center. A co-axial cylindrical tube 12 is an integral part of the base unit 3 extending perpendicularly from the center of the circular front face 11. The cylindrical tube 12 narrows at its extended end 13, as shown in FIG. 3 and FIG. 6. Relief cuts 10 are molded into the extended end 13 of the cylindrical tube 12 to allow for brief expansion as the raised edge 9 of the adapter sleeve 2 is inserted. A circular cavity 14, shown in FIG. 3, is formed on the backside of the front circular face 11 as part of the base unit 3, and serves as the holding area for the repellant substance 15, as shown in FIG. 6 and FIG. 7. Equally spaced female locking notches 16 are molded into the outer perimeter of the circular front face 11, as shown in FIG. 3 and FIG. 4.

The Weather Shroud: The weather shroud 4, as seen in FIGS. 1,2,3,4, and 7 is circular and dome shaped with a taper to a small end opening 17 at its domed end. The opposite, large end opening 18, is sized to mate to the circular rear edge of the base unit 3. There are equally spaced male locking tabs 19 extending from the edge of the large end opening 18, to enable the securing of the weather shroud 4 to the base unit 3.

### Purpose and Function of Component Parts

Hemi-sleeves; Adapter Sleeve FIGS. 5 and 6 present various views of adapter hemi-sleeves 21 and 22 which provide a means of securing the assembled device to either ⅜ in-diameter, ½ in-diameter, or a ⅝ in. diameter mooring line 6. This is accomplished by providing to a user, a selection of three sets of paired hemi-sleeves 21, 22, each pair designed with a different inside diameter. Heavy-duty insect repellers 1 may also be manufactured in correspondingly larger relative sizes to function on larger-sized mooring lines 6.

Securement on a mooring line 6 is further assisted by use of the raised/spiked edges 5 on the inner surface 23 of each hemi-sleeve 21, 22. After the adapter sleeve 2 is placed in position on the mooring line 6, the front face 11 of the base unit 3 is pushed over the raised edge 9, in the locking direction 20, of the adapter sleeve 2 until the raised edge 9 of the adapter sleeve 2 passes through the extended end 13 of the base unit 3. The seating of the adapter sleeve 2 into the base unit 3 forces the raised/spiked edges 5 of the adapter sleeve 2 into the outer surface of the mooring line 6. Thus, the adapter sleeve 2 and base unit 3 are secured into position on the mooring line 6.

The Base Unit: FIGS. 2, 3, 4, 5, and 7 present various views of the base unit 3, which serves to provide a means of establishing an insect repelling barrier around the mooring line 6. This is accomplished by use of the circular cavity 14 as a holding area for the repellent substance 15, as seen in FIG. 6 and FIG. 7. The base unit 3 also firmly holds the adapter sleeve 2 in place on the mooring line 6. This is accomplished by the interior design of the cylindrical tube 12 matching the exterior design of the adapter sleeve 2 and the locking action of the extended end 13 of the cylindrical tube 12 after the raised edge 9 of the adapter sleeve 2 passes through its extended end 13. Further, the base unit 3 has female locking notches 16 which accept the male locking tabs 19 of the weather shroud 4.

The Weather Shroud: FIGS. 1, 2, 3, 4, and 7 present various views of the weather shroud 4. The primary function of the weather shroud 4 is to protect the surface of the repellant substance 15 from weather elements, flying insects, dirt or other contamination, and accidental human contact. The dome shape of the weather shroud 4 tapers to a small end opening 17 which limits the exposure to the repellent substance 15. Additionally, the large end opening 18 of the weather shroud 4 firmly connects to the base unit 3 by means of the male locking tabs 19 interlocking with female locking notches 16 of the base unit 3.

### Installation of the Insect Repeller

Assuming that a boat or water vessel is to be tied to a dock or shore tie point, installation of the insect repeller 1 may be explained by reference to FIG. 3 and FIG. 4, and is accomplished in the following sequential steps:

1. A user, working from the shore-tied end of the mooring line 6, begins by untying the mooring line 6 from the shore tie point

2. The user then threads the free end of the mooring line 6 through the center of the base unit 3 from the circular front face 11 end and continues through the cylindrical tube 12. The user then threads the free end of the mooring line 6 through the large open end 18 of the weather shroud and continues out the small open end 17 of the weather shroud 4. With both the base unit 3 and the weather shroud 4 threaded onto the mooring line 6, the free end can then be re-tied to the shore connection point.

3. Next, the user chooses the correct size of paired hemi-sleeves 21, 22, and positions the mooring line 6 between the pair at the desired location along the length of the mooring line 6. The rounded flanges 7 of both hemi-sleeves 21, 22 should be facing towards the boat.

4. While holding the hemi-sleeves 21, 22 in place on the mooring line 6, the user slides the circular front face 11 of the base unit 3 over the raised edges 9 of the hemi-sleeves 21, 22. In this manner the adapter sleeve 2 becomes fully formed. The base unit 3 is then moved onto the adapter sleeve 2 until the adapter sleeve 2 has been inserted through the cylindrical tube 12 and is seated within the base unit 3.

5. With the base unit 3 now secured to the mooring line 6, the user then slides the weather shroud 4 over the cylindrical tube 12 (in the direction of shroud locking 20) and aligns the male locking tabs 19 of the weather shroud 4 with the female locking notches 16 of the base unit 3. Once aligned, the weather shroud 4 can be moved forward and secured onto the base unit 3, thus completing the installation

It is recognized that one knowledgeable in this field of endeavor, and skilled in the art, has the capability to design or produce similar, or other embodiments of this inventive concept. However all such variations, alterations, or modifications are entirely conceivable as being within the intent and scope of the present inventive concept. In particular, the essence of the inventive concept resides in a compact, insect-repelling device that is attachable to a boat mooring line, or any similar rope-like connecting means. Any number of connections, geometric shapes, operational linkages, functions, and combinations thereof may be used to effectuate the engagement and operation of the device.

What is claimed is:

1. A device for preventing the movement of ants and crawling insects along the length of a rope, wire, line, cord, or other similarly structured object, comprising
a dome-shaped weather shroud having a hollow, length-wise channel;
a base unit having a cavity and an integral co-axial, hollow cylindrical tube;
an adapter sleeve;
a means of securing said adapter sleeve to said rope, wire, line, cord, or other similarly structured object; and.
a means of attaching said weather shroud to said base unit while simultaneously securely enclosing said adapter sleeve within the internal confines of said weather shroud.

2. A device for preventing the movement of ants and crawling insects along a mooring line connecting a dock, pier, or shoreline tying point to a boat or other vessel or object, comprising
a dome-shaped weather shroud having a small end opening and a large end opening and further having hollow, length-wise channel;
a base unit having a circular cavity and a perpendicularly-oriented co-axial cylindrical tube;
an adapter sleeve comprising two hemi-sleeves, each having internal ridges/spikes;
a means of securing said adapter sleeve to said mooring line; and
a means of attaching said weather shroud to said base unit, while simultaneously securely enclosing said adapter sleeve within the internal confines of said weather shroud.

3. A device as in claim 2, wherein
a) said adapter sleeve comprises two hemi-sleeves with internal raised ridges, and which are longitudinally identical to each other; and
b) said means of attaching comprises a plurality of male locking tabs integral to the perimeter of said weather shroud and compatible co-aligned female locking notches integral to the perimeter of said base unit.

4. A method for preventing crawling insects from traversing a mooring line which is connected from a dock, pier, or shoreline tie-point, to a boat, or other vessel or structure, comprising the following steps:
constructing a base unit comprising a circular cavity within a flanged circular base plate with an integral hollow cylindrical tube extending co-axially and perpendicularly through said base plate, said base plate further having a plurality of female locking notches molded into the perimeter of said flange; and
constructing a weather shroud comprising a tapered cylinder device having a large-end opening and a small-end opening and further, having a plurality of male locking tabs integral to the outer perimeter of said large-end opening;
constructing an adapter sleeve comprising two longitudinally identical hemi-sleeves, each hemi-sleeve having internal raised ridges/spikes, whereby the outer circumference of the mating of both hemi-sleeves constitutes a circular dimension equivalent to the inner circumference of said cylindrical tube;
placing a semi-solid, sticky insect-repelling substance in the confines of said circular cavity;
axially aligning said weather shroud and said base unit and thereafter inserting a mooring line sequentially through the interiors of said weather shroud and said base unit;
placing a matching pair of said hemi-sleeves upon a segment of said mooring line proximate the interior of said cylindrical tube of said base unit; and
moving said weather shroud along the axis of said mooring line and over the exterior surface of said adapter sleeve until accomplishing the latching of said male locking tabs into said female locking notches of said base unit.
